(19) United States
(12) Patent Application Publication
(10) Pub. No.: US 2007/0026895 A1
(43) Pub. Date: Feb. 1, 2007

(54) Modular base station components for use in wireless communication systems

(76) Inventors: Christopher J. Capece, Lebanon, NJ (US); Michael A. Crocker, Long Valley, NJ (US); Vincent J. DeRossi, Brooklyn, NY (US); Thomas L. Frederick, Reynoldsburg, OH (US); Michael F. Garyantes, Warren, NJ (US); Elizabeth Hall Kujan, Morristown, NJ (US); Behzad D. Mottahed, Upper Montclair, NJ (US); Max A. Solondz, Morris, NJ (US); Krishnamurthy Sreenath, Randolph, NJ (US)

Correspondence Address: CARLSON, GASKEY & OLDS, P.C., 400 W MAPLE RD, SUITE 350, BIRMINGHAM, MI, 48009, US

(21) Appl. No.: 11/194,854

(22) Filed: Aug. 1, 2005

(51) Int. Cl. H04B 1/38; H04M 1/00

(52) U.S. Cl. 455/561

(57) ABSTRACT

A wireless communication system (20) includes a base station (22) that is capable of communicating with a plurality of mobile stations (24). The base station includes a modular device (50) that allows flexibility in locating the various operative electronic components (52, 54, 56, 58) of the base station. Disclosed examples include a radio frequency head module (55) that packages components traditionally associated and located with a radio in a manner that allows them to be located with the Tx and Rx portions of the radio or at a remote location. One example includes a radio frequency coupling for communications between the radio (54) and the radio frequency head module (55). Other examples include intermediate frequency couplings (70, 74).

### FIELD OF THE INVENTION

This invention generally relates to telecommunications. More particularly, this invention relates to wireless communication systems.

### DESCRIPTION OF THE RELATED ART

Wireless communication systems are well known and in widespread use. The most common use of such systems is for voice communications using cell phones. More recently, uses of such systems for data communications, video communications and combinations of voice, data and video have grown in popularity. As wireless service providers increase their capabilities, there are increasing demands for such services. With increasing demand, comes increasing needs for flexibility in establishing and arranging system components.

A conventional cellular system comprises a number of cell sites or base transceiver stations geographically distributed to support the transmission and reception of communication signals to and from the wireless or mobile units. Each cell site handles communications within, as well as outside the cell. Moreover, the overall coverage area for the cellular system may be defined by the union of cells for all of the cell sites, where the coverage areas for nearby cell sites overlap to ensure, where possible, contiguous communication coverage within the outer boundaries of the system's coverage area.

When active, a wireless unit receives signals from at least one base station over a forward link (e.g., downlink) and transmits signals to at least one base station over a reverse link (e.g., uplink). Several approaches have been developed for defining links or channels in a cellular communication system, including time-division multiple access (“TDMA”), code-division multiple access (“CDMA”) and orthogonal-frequency division multiple access (“OFDMA”), for example.

Each base transceiver station typically comprises one or more radio towers and one or more antennas for communicating with each of the wireless units in that cell. Moreover, each base transceiver station includes transmission equipment for communicating with a mobile switching center (“MSC”). A mobile switching center is responsible for, among other things, establishing and maintaining calls between the wireless units, between a wireless unit and a wire line unit through a public switched telephone network (“PSTN”), as well as between a wireless unit and a packet data network (“PDN”), such as the Internet. A base station controller (“BSC”) administers the radio resources for one or more base transceiver stations and relays this information to the MSC.

To this purpose, the transmission equipment within each base transceiver station comprises at least one radio frequency module (“RFM”). In addition to a power amplifier and a filter, each RFM includes at least one radio for communicating with mobile telephones over the air interface. Moreover, the transmission equipment also comprises at least one base unit. Each base unit may include one or more processors for handling communications between the RFM and the mobile switching center, as well as channel cards. Conventional wisdom is to position the RFM remotely from the base unit and to use a cable connection for communications between them.

It would be useful to have greater flexibility in arranging the components associated with a base transceiver station. This invention provides a modular approach that allows the operative components of a base transceiver station to be located together or separated and located remotely from each other.

### SUMMARY OF THE INVENTION

In one aspect of the instant invention, the components of a base station may be divided up into functional modules and packaged such that a modular assembly approach becomes possible. The operative components of one module can be located remotely from those of another module. Alternatively, the separate modules can be installed at the same location. Having the ability to select from various geographical or positional relationships between the different modules allows greater flexibility in arranging wireless communication systems. Additionally, multiple modules of a selected type can be used together to scale an installation to accommodate a desired number of carriers. One advantage to such an arrangement is that a base station can be upgraded in the field to accommodate more carriers over time without requiring replacing all of the operative components associated with the base station.

An exemplary wireless transceiver device includes a channel element at a first location. A radio at the first location is associated with the channel element for communication between them. A radio frequency head module includes at least one amplifier and at least one filter. At least one radio frequency coupling between the radio and the radio frequency head module facilitates at least radio frequency communications between the radio and the radio frequency head module.

In one example, the radio frequency head module comprises a power amplifier, a radio frequency sampling converter, a filter-duplexer and a low noise amplifier. In this example, the entire radio frequency head module is at a second location remote from the first location of the channel element and the radio.

In one example, the radio frequency coupling comprises a plurality of bidirectional, coaxial cables. Example communications between the radio and the radio frequency head module comprise at least one of a control signal or an alarm signal transmitted along at least one of the coaxial cables.

Another example wireless transceiver device has a channel element at a first location. A first radio portion is associated with the channel element at the first location. A radio frequency head module in this example includes at least one amplifier, at least one filter and a second radio portion, which is a frequency converter. The frequency converter converts signals from a frequency used for communications between the first and second radio portions and at least one frequency used for communications with mobile stations. At least one intermediate frequency coupling between the first radio portion and the second radio portion facilitates at least intermediate frequency communications between the first and second radio portions.

In one example, the intermediate frequency coupling is analog. In another example, it is digital. An example that includes a digital intermediate frequency coupling has a multiplexing unit associated with each of the radio portions for multiplexing digital signals before they are communicated over the intermediate frequency coupling. The multiplexing units also demultiplex signals received over the intermediate frequency coupling.

The various features and advantages of this invention will become apparent to those skilled in the art from the following detailed description. The drawings that accompany the detailed description can be briefly described as follows.

### BRIEF DESCRIPTION OF THE DRAWINGS

FIG. 1 schematically shows selected portions of a wireless communication system designed according to an embodiment of this invention.

FIG. 2 schematically shows a modular arrangement of base transceiver station components arranged according to one example embodiment.

FIG. 3 schematically shows a modular arrangement of base transceiver station components arranged according to another example embodiment.

FIG. 4 schematically shows a modular arrangement of base transceiver station components arranged according to a third example embodiment.

### DETAILED DESCRIPTION

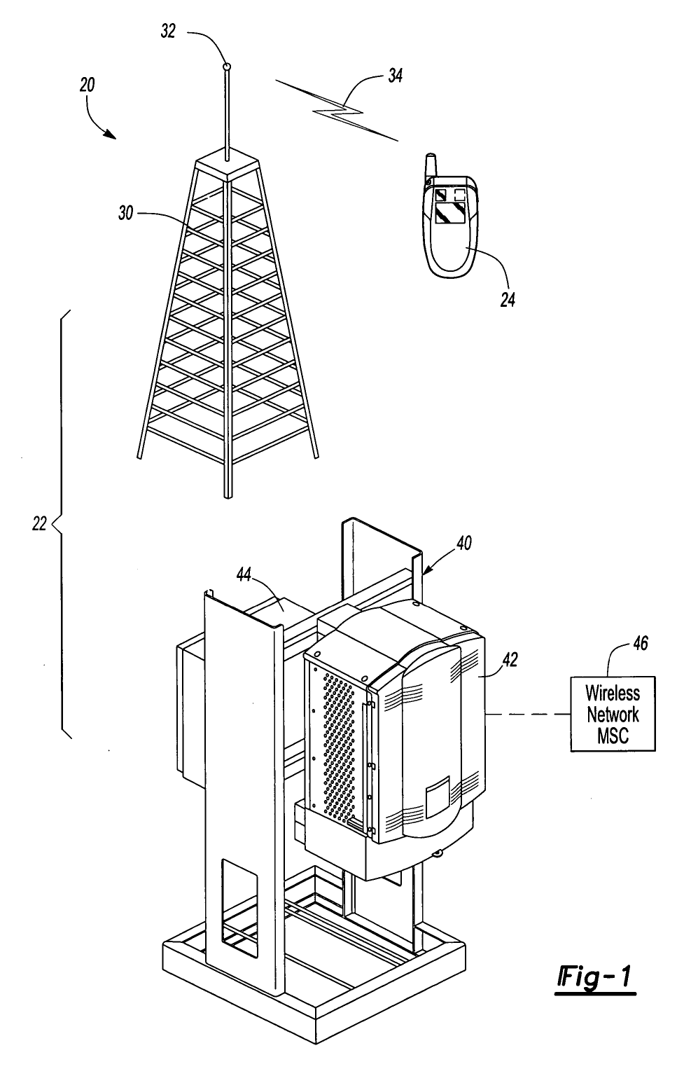

FIG. 1 schematically shows selected portions of a wireless communication system 20. A base station 22 communicates with at least one mobile station 24 using known techniques. The example base station 22 includes a tower 30 that supports at least one antenna 32 useful for transmitting and receiving wireless communication signals between the base station 22 and the mobile station 24 over an air interface 34.

The base station 22 also includes a structure 40 that supports at least one housing 42 for operative electronic components of the base station and a power unit 44, for example. At least some of the components in the example housing 42 are responsible for communications between the base station 22 and a wireless communication network 46.

In one example, the housing 42 encloses only some of the operative electronics associated with the base station at the location of the structure 40 while other components are located remotely in at least one other location. In such an example, the housing 42 may be at the location of the tower 30 or another location. In one example, a separate housing resembling the housing 42 is provided at each location where appropriate components of the base station 22 are located.

In another example, all of the operative electronic components are housed within the housing 42. One advantage to the disclosed example embodiments is that they allow a system designer to choose how to locate the various components to best suit their particular needs.

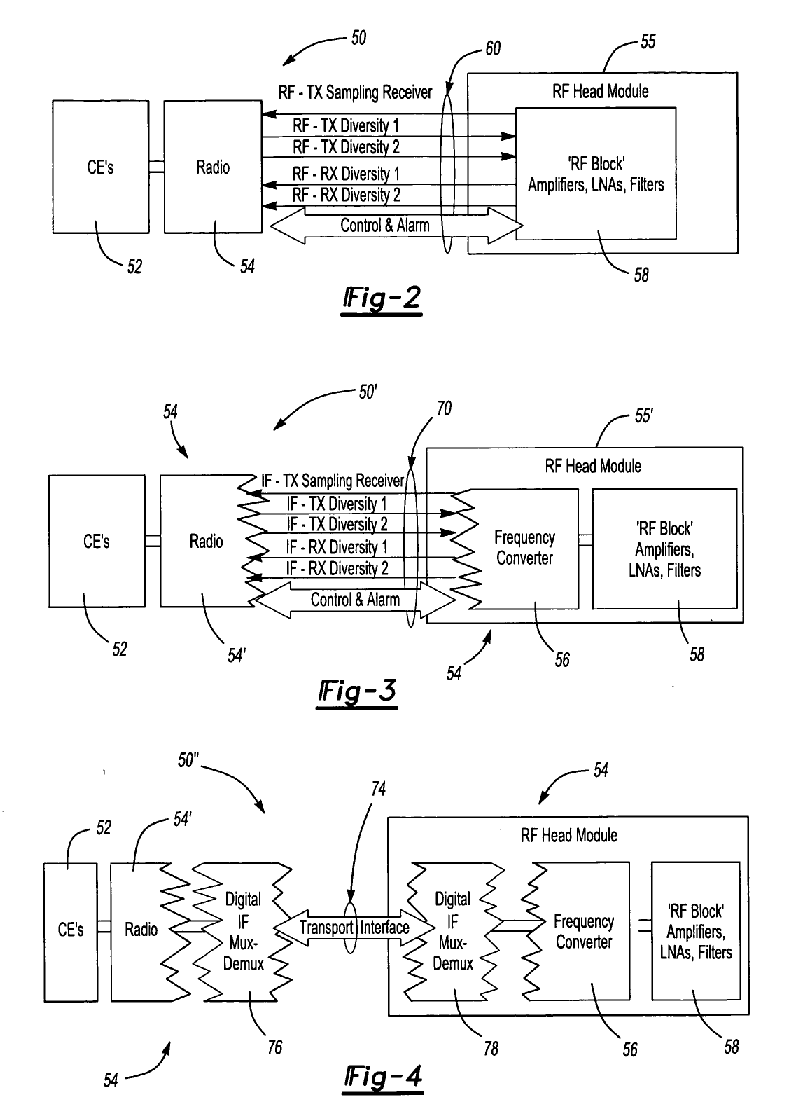

FIG. 2 schematically shows one example modular device 50 that includes the operative electronic components of the base station 22. In this example, a channel element 52 operates in a generally known manner to facilitate communications between the base station 22 and a mobile switching center of the wireless network 46. A radio 54 is located in the same general location of the channel element 52. In one example, the radio 54 and the channel element are supported in the housing 42.

The modular device 50 also includes a radio frequency head module (RFHM) 55 including a radio frequency block 58 that includes at least one amplifier and at least one filter. In one example, the RFHM 55 includes a housing that can be located entirely separately from another housing (such as the housing 42) that contains the channel element 52, the radio 54 or both. This allows the RFHM 55 to be positioned at any convenient location remote from the tower 30, the housing 42 or both.

In traditional base station arrangements, the components included in the radio frequency block 58 and the radio 54 are all in the same location. This example allows for them to be separated by a selected distance and positioned in remote locations. Another way to consider the illustrated example is to consider it as dividing up the traditional radio functions into separable functional blocks or modules. Therefore, this example includes a radio frequency coupling 60 for facilitating communications between the radio 54 and the appropriate components of the radio frequency head 58. In one example, the radio frequency coupling comprises at least one coaxial cable for carrying radio frequency signals between the radio 54 and the radio frequency block 58.

One example channel element 52 includes all the individual processing elements appropriate to the air interface supported by the base station 22. More than one channel element may be packaged together. Multiple channel elements are combined in one example to form a single air interface RF Channel (RFC).

The example radio 54 includes a Tx radio functional block that multiplexes all the individual RFCs onto a single data stream, which is the full RF bandwidth wide, for communicating the entire set of traffic signals in the transmit path. That data stream is then converted to at least one RF frequency for transmission over the radio frequency coupling 60. All traffic signals (two transmit, two receive, and one sampling receive) are sent via RF.

The radio frequency block 58 includes a power amplifier, an RF sampling converter, a filter-duplexer and a low noise amplifier. For supporting higher RF output power, additional power amplifier modules could be combined in some fashion. In one example, the components responsible for all of these functions are housed in one package. As mentioned above, this package can be located separately from the channel element 52 and the radio 54. One example includes placing the RFHM 55 package within the same housing as the radio 54. In such examples, the packaging of the RFHM 55 may accommodate a docking station type of insertion of the package into the housing containing the radio 54. The radio frequency coupling 60 in such an example is accommodated in the housing so that insertion of the radio 54 and the RFHM 55 into the housing simultaneously establishes the connection for realizing the radio frequency coupling 60.

The Tx radio functional block of the radio 54 in this example also accommodates Peak-to-Average Ratio Reduction (PARR), Digital Pre-Distortion (DPD), and Closed Loop Gain Control (CLGC) functions. For DPD, the RF sampled signals from the RF sampling converter are provided to the radio 54 because of the need for feedback from the Tx Radio functional block to the Tx sampling functional block in order to control and implement CLGC and DPD.

An Rx radio functional block of the radio 54 receives the entire stream of RF frequency signals on the coupling 60, which contains multiple RFCs. In one example, the Rx radio functional block down converts and translates the received signals into a single data stream, which is then demultiplexed into multiple RFCs and then multiple individual CEs for use by the channel element 52.

Another feature of the example of FIG. 2 is that at least one of alarm or control signals are communicated between the radio 54 and the radio frequency block 58. In one example, alarm or control signals are multiplexed with other signals such as the sampling RF port onto one line of the coupling 60 and transmitted using radio frequency signals. One example includes multiplexing alarm or control signals with a DC or AC feed. In another example, the alarm or control signals are transmitted using a dedicated interface or protocol. Even in such examples, the radio frequency coupling 60 can carry such signals.

The Table 1 below shows example frequencies useful for some implementations. The notations in the function and description columns correspond to the notations in FIG. 2. It is worth noting that the “Transmitter Input” frequency listings in Table 1 are over an extended bandwidth in order to accommodate baseband digital pre-distortion techniques that may expand the bandwidth.

TABLE 1

| | | | | Suggested |
|---|---|---|---|---|
| | | PCS | Cellular | Nominal RF Levels & |
| | | Frequency | Frequency | Gain per Carrier |
| Function | Description | (MHz) | (MHz) | (dBm) |
| Tx1 | Diversity 1 Transmitter Input | 1915-2005 | 854-909 | 0 dBm |
| Rx1 | Diversity 1 Receiver Output | 1850-1915 | 824-849 | 28 dB LNA gain |
| Ant1 | Diversity 1 Antenna | 1850-1995 | 869-894 | 43 dB Tx gain |
| Tx2 | Diversity 2 Transmitter Input | 1915-2005 | 854-909 | 0 dBm |
| Rx2 | Diversity 2 Receiver Output | 1850-1915 | 824-849 | 28 dB LNA gain |
| Ant2 | Diversity 2 Antenna | 1850-1995 | 869-894 | 43 dB Tx gain |

FIG. 3 shows another example modular device 50′. In this example, the radio 54 has a first portion 54′ associated with the channel element 52 at a first location and a second portion 56 associated with the RFHM 55. In this example, the second portion 56 of the radio comprises a frequency converter. An intermediate frequency coupling 70 facilitates communications between the first radio portion 54′ and the second portion 56. An intermediate frequency, as that term is used in this description, is a lower frequency than those used for communications over the air interface 34.

In one example, the first radio portion 54=40 contains all digital signal processing functions such as channel multiplexing/demultiplexing, PARR, DPD, CLGC and modulation or demodulation onto intermediate frequencies in the ranges shown in Table 2 below. The second portion 56 of the radio 54 (i.e., a frequency converter) handles the radio frequency conversion (up or down, depending on the direction of communication) onto the frequency band of interest (i.e., Cellular, PCS or 2100 MHz). The remaining functional blocks schematically shown in FIG. 3 are similar to the corresponding blocks in the previous example.

In one example, the actual interconnections for realizing the intermediate frequency coupling 70 are similar to the previous option with multiple coaxial cables (50 ohms) except that cables will be carrying lower frequency intermediate frequency signals. Other examples include other cables a backplane connection or another device for the intermediate frequency coupling 70. In this example, the intermediate frequency coupling 70 carries analog intermediate frequency signals. Example signaling ranges useful in some examples are shown in Table 2 below.

TABLE 2

| | | Suggested | Suggested | Suggested |
|---|---|---|---|---|
| | | Frequency | Frequency | IF Levels & |
| | | (MHz) | (MHz) | Net Gain per Carrier |
| Function | Description | (PCS) | (Cellular) | (dBm) |
| Tx1 | Diversity 1 Transmitter Input | 175-275 | 175-275 | 0 dBm |
| Rx1 | Diversity 1 Receiver Output | 75-165 | 75-165 | 38 dB net gain |
| Ant1 | Diversity 1 Antenna | 1850-1995 | 869-894 | 53 dB Tx net gain |
| | Sampling Radio Output/ | TBD | TBD | TBD |
| | Control/DC Power | | | |
| Tx2 | Diversity 2 Transmitter Input | 175-275 | 175-275 | 0 dBm |
| Rx2 | Diversity 2 Receiver Output | 75-165 | 75-165 | 38 dB LNA gain |
| Ant2 | Diversity 2 Antenna | 1850-1995 | 869-894 | 53 dB Tx gain |

Control and alarm signals in this example are communicated in a similar manner as used for the example of FIG. 2. One example includes multiplexing the control or alarm signals on a coaxial cable or another device that is part of the coupling 70.

FIG. 4 shows another example arrangement of a modular device 50″. This example includes a digital intermediate frequency coupling 74. In one example, the coupling 74 comprises a digital transport cable such as an electrical conductor (e.g., copper wire). In another example, the coupling 74 comprises a fiber optic cable such as a multi-mode fiber optic cable or a single-mode fiber optic cable.

In this example, the radio 54 is essentially includes four functional blocks. A first radio portion 54′, a digital multiplexing section 76 that multiplexes all the digital signals together onto the digital transport of the intermediate frequency coupling 74, a digital demultiplexing section 78 that demultiplexes the digital signals and the frequency converter 56.

In this example the first portion 54′ of the radio has similar functions as in the previous example, but the modulation and demodulations are done digitally with different intermediate frequencies. These digital intermediate frequencies will be multiplexed in the digital multiplexing section 76. The resulting composite digital signal is transported to the digital demultiplexing section 78 over the intermediate coupling 74. Although the section 76 is labeled a multiplexing section for convenience, those skilled in the art will appreciate that it also performs demultiplexing, depending on the direction of communication across the coupling 74. The same is true of the demultiplexing section 76.

The frequency converter 56 is responsible for up or down conversion to the desired frequency band for communications over the air interface 34.

In this example, alarm or control signals are multiplexed onto the composite signal before transport across the digital link 74.

The following Table 3 lists example signaling interfaces useful in embodiments including a digital intermediate frequency coupling 74 between the multiplexing/demultiplexing portions 76 and 78.

TABLE 3

| | | Suggested | Suggested |
|---|---|---|---|
| | | Frequency | Frequency |
| | | (MHz) | (MHz) |
| Function | Description | (PCS) | (Cellular) |
| Tx1 | Diversity 1 Transmitter Digital | Digital | Digital |
| | IF Input | | |
| Rx1 | Diversity 1 Receiver Digital IF | Digital | Digital |
| | Output | | |
| Ant1 | Diversity 1 Antenna | 1850-1995 | 825-894 |
| | Sampling Radio Digital IF Output | Digital | Digital |
| Tx2 | Diversity 2 Transmitter Digital | Digital | Digital |
| | IF Input | | |
| Rx2 | Diversity 2 Receiver Digital IF | Digital | Digital |
| | Output | | |
| Ant2 | Diversity 2 Antenna | 1850-1995 | 825-894 |

The disclosed examples show how a modular approach to providing base station components can facilitate greater flexibility in arranging a wireless communication system. For example, the modular approach allows changing the power or channel capacity of a base station much easier and economically with the disclosed approach. If it is desirable to upgrade an installation to support more carriers, for example, that may be accomplished by changing an appropriate module to increase the power capacity to support the added channels. It is possible for example, to add another module or element without altering the existing components or to replace an entire module, depending on the needs of a particular situation.

The following tables 4, 5 and 6 provide example configurations that are possible with the disclosed modular approach.

TABLE 4
PCS CDMA Power Level Configurations - 1900 MHz

| | Number | | | | |
|---|---|---|---|---|---|
| | of Carriers | | Power per Carrier | | Total |
| | Div. 1 | Div. 2 | Div. 1 | Div. 2 | Power |
| | Antenna | Antenna | Antenna | Antenna | (per antennas) |
| Configuration | (C) | (C) | (watts) | (watts) | (watts) |
| 1 | 3 | 0 | 10 mw | 0 w | 1 × 30 mw |
| 2 | 6 | 5 | 1 w | 1 w | 2 × 6 w |
| 3 | 3 | 0 | 16 w | 0 w | 1 × 48 w |
| 4 | 3 | 3 | 16 w | 16 w | 2 × 48 w |
| 5 | 6 | 5 | 16 w | 16 w | 2 × 96 w |

TABLE 5
Cellular Power Level Configurations - 850 MHz

| | Number of | | | | |
|---|---|---|---|---|---|
| | Carriers | | Power per Carrier | | Total |
| | Div. 1 | Div. 2 | Div. 1 | Div. 2 | Power |
| | Antenna | Antenna | Antenna | Antenna | (per antennas) |
| Configuration | (C) | (C) | (watts) | (watts) | (watts) |
| 6 | 3 | 0 | 10 mw | 0 w | 1 × 30 mw |
| 7 | 6 | 5 | 1 w | 1 w | 2 × 6 w |
| 8 | 3 | 0 | 20 w | 0 w | 1 × 60 w |
| 9 | 3 | 3 | 20 w | 20 w | 2 × 60 w |
| 10 | 4 | 3 | 20 w | 20 w | 2 × 80 w |

TABLE 6
PCS UMTS Power Level Configurations - 1900 MHz

| | Number | | | | |
|---|---|---|---|---|---|
| | of Carriers | | Power per Carrier | | Total |
| | Div. 1 | Div. 2 | Div. 1 | Div. 2 | Power |
| | Antenna | Antenna | Antenna | Antenna | (per antennas) |
| Configuration | (C) | (C) | (watts) | (watts) | (watts) |
| 11 | 1 | 0 | 10 mw | 0 w | 1 × 30 mw |
| 12 | 2 | 1 | 1 w | 1 w | 2 × 6 w |
| 13 | 1 | 0 | 20 w | 0 w | 1 × 20 w |
| 14 | 1 | 1 | 20 w | 20 w | 2 × 20 w |
| 15 | 2 | 1 | 20 w | 20 w | 2 × 40 w |

The disclosed approach to arranging base station components facilitates upgrades in the field without requiring total replacement or significant reworking of an existing installation. This is advantageous to support growing use of wireless communication resources in areas that experience population growth, for example.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

We claim:

1. A wireless transceiver device, comprising:
a radio at a first location and associated with a channel element;
a radio frequency head module comprising at least one amplifier and at least one filter; and
at least one radio frequency coupling between the radio and the radio frequency head module for facilitating at least radio frequency communications between the radio and the radio frequency head module.

2. The device of claim 1, wherein the radio frequency head module comprises a power amplifier, a radio frequency sampling converter, a filter-duplexer and a low noise amplifier, and the radio frequency head module located at a second location remote from the first location.

3. The device of claim 1, wherein the radio frequency coupling comprises a plurality of bi-directional, coaxial cables.

4. The device of claim 1, wherein communications between the radio and the radio frequency head module comprise at least one of a control signal or an alarm signal.

5. The device of claim 1, wherein
the radio frequency head module comprises a sampling converter for providing at least one sampled signal to the radio; and
the radio and the radio frequency head module are coupled such that feedback signals from the radio to the sampling converter accommodate at least one of digital pre-distortion or closed loop gain control.

6. The device of claim 5, wherein the sampled signal is multiplexed with at least one other signal and communicated from the radio frequency head module to the radio over a radio frequency channel over the cable coupling.

7. The device of claim 6, wherein the at least one other signal comprises at least one of an alarm or a control signal.

8. The device of claim 1, wherein
the channel element provides at least one radio frequency channel;
the radio multiplexes all radio frequency channels provided by the channel element onto a single data stream; and
the multiplexed radio frequency channels are converted to radio frequencies for communication with the radio frequency head module over the radio frequency coupling.

9. A wireless transceiver device, comprising:
a first radio portion at a first location and associated with a channel element;
a radio frequency head module comprising at least one amplifier, at least one filter and a second radio portion including a frequency converter; and
at least one intermediate frequency coupling between the first radio portion and the second radio portion for facilitating at least intermediate frequency communications between the first and second radio portions.

10. The device of claim 9, wherein the first radio portion and the converter each convert radio frequency signals of a desired frequency into intermediate frequency signals for communicating with the other of the converter or the first radio portion.

11. The device of claim 10, wherein the first radio portion and the converter each convert received intermediate frequency signals back into radio frequency signals of the desired frequency for communication to another device.

12. The device of claim 9, wherein the radio frequency head module comprises a power amplifier, a radio frequency sampling converter, a filter-duplexer and a low noise amplifier, and the radio frequency head module is located at a second location remote from the first location.

13. The device of claim 9, wherein the intermediate frequency coupling comprises at least one bi-directional, coaxial cable.

14. The device of claim 9, wherein communications between the first radio portion and the converter of the radio frequency head module comprise at least one of a control signal or an alarm signal.

15. The device of claim 9, wherein the first radio portion and the converter communicate over the intermediate frequency coupling using analog signals.

16. The device of claim 9, wherein the first radio portion and the converter communicate over the intermediate frequency coupling using digital signals.

17. The device of claim 16, comprising:
a multiplexing unit associated with the first radio portion for multiplexing a plurality of digital intermediate frequency signals before communicating said signals over the intermediate frequency coupling; and
a demultiplexing unit associated with the converter for demultiplexing the multiplexed digital intermediate frequency signals.

18. The device of claim 16, wherein the intermediate frequency coupling comprises at least one of a metal conductor, a fiber-optic conductor, a cable or a backplane.
